(19) United States
(12) Patent Application Publication
(10) Pub. No.: US 2019/0302539 A1
(43) Pub. Date: Oct. 3, 2019

(54) LIQUID CRYSTAL DISPLAY DEVICE AND ELECTRONIC APPARATUS

(71) Applicant: SHARP KABUSHIKI KAISHA, Osaka (JP)

(72) Inventors: KEI SHINADA, Sakai City (JP); TOMOHISA MATSUSHITA, Sakai City (JP); MASAHIRO SHIMIZU, Sakai City (JP); TETSUO FUKAYA, Sakai City (JP); TAICHI SASAKI, Sakai City (JP)

(21) Appl. No.: 16/371,548

(22) Filed: Apr. 1, 2019

(30) Foreign Application Priority Data
Apr. 2, 2018 (JP) 2018-070792

(51) Int. Cl. G02F 1/1337; G09G 3/3225; G02F 1/1343

(52) U.S. Cl. CPC G02F 1/133711; G02F 2001/133354; G02F 1/1343; G09G 3/3225

(57) ABSTRACT

A liquid crystal display device includes an active matrix substrate, a counter substrate, and a liquid crystal layer. The active matrix substrate includes an alignment film defining an initial alignment azimuth, and a first electrode and a second electrode to generate a fringing field. The counter substrate includes a transparent substrate and a third electrode provided on a side of the transparent substrate closer to the liquid crystal layer. The first electrode is a pixel electrode, and the second electrode is a common electrode. A DC voltage Vd is applied to the third electrode, the DC voltage Vd being different from a common voltage Vcom which is applied to the common electrode.

### BACKGROUND

### 1. Technical Field

The present invention relates to a liquid crystal display device, and more particularly to a liquid crystal display device which performs display in an FFS mode. Moreover, the present invention also relates to an electronic apparatus having such a liquid crystal display device.

### 2. Description of the Related Art

In recent years, the Fringe Field Switching (FFS) mode is often adopted as a display mode in the liquid crystal display devices used in smartphones and tablets. Liquid crystal display devices of the FFS mode are disclosed, for example, in Japanese Laid-Open Patent Publication No. 2002-182230 (“hereinafter Patent Document 1”).

In a liquid crystal display device of the FFS mode, a pair of electrodes for generating a fringing field are provided on one of a pair of substrates between which a liquid crystal layer of a horizontal alignment type is interposed. Typically, the pair of electrodes are: a pixel electrode having a plurality of slits; and a common electrode which is disposed under the pixel electrode via an insulating layer. When a voltage is applied between the pixel electrode and the common electrode, a fringing field is generated, and the alignment azimuth of liquid crystal molecules is altered by the alignment regulating force of this fringing field.

Thus, in a liquid crystal display device of the FFS mode, alignment of liquid crystal molecules is controlled by using a fringing field. In the FFS mode, liquid crystal molecules rotate in a plane which is parallel to the display surface, and thus high viewing angle characteristics are obtained.

Previously, rubbing treatments were often adopted for the alignment films in a liquid crystal display device of the FFS mode. Recently, however, use of a photo-alignment treatment (i.e., use of photo-alignment films as the alignment films) has been proposed in order to reduce unevenness in alignment, etc.

On the other hand, an active matrix substrate of a liquid crystal display device includes a thin film transistor (hereinafter “TFT”) for each pixel, the thin film transistor serving as a switching element. As such TFTs, TFTs in which an oxide semiconductor layer is used as the active layer (hereinafter referred to as “oxide semiconductor TFTs”) are known. Japanese Laid-Open Patent Publication No. 2012-134475 (hereinafter “Patent Document 2”) discloses a liquid crystal display device in which InGaZnO (an oxide of indium, gallium, and zinc) is used as the active layer of each TFT.

An oxide semiconductor TFT is capable of operating more rapidly than an amorphous silicon TFT. Moreover, an oxide semiconductor film is formed through a simpler process than that used for a polycrystalline silicon film, and therefore is applicable to devices which require a large geometric area. Therefore, oxide semiconductor TFTs are expected to be high-performance active elements that can be produced with fewer production steps and less production cost.

Furthermore, since an oxide semiconductor TFT excels in off-leak characteristics, it allows to employ driving methods under which display is performed with less frequent image rewrites. For example, when displaying a still image or the like, an operation may be performed so that image data is rewritten once per second. Such a driving method, referred to as pause-driving or low frequency driving, etc., is able to greatly reduce power consumption of the liquid crystal display device.

A liquid crystal display device of the FFS mode has a problem in that flickering becomes easier to be perceived as the driving frequency decreases (i.e., as the one frame period increases).

Moreover, as a photo-alignment film material for use in a liquid crystal display device of the FFS mode, the inventors have considered some materials whose resistivity is higher than conventional. The photo-alignment film materials that were considered excel in terms of improving the contrast ratio, anti-image sticking property, and long-term reliability. It has been found through a study of the inventors that using such aforementioned photo-alignment film materials may result in a new problem in that the optimum common voltage Vcom (which hereinafter may be referred to as the “optimum Vcom”) may significantly shift during use of the liquid crystal display device.

### SUMMARY

The present invention has been made in view of the aforementioned problem, and an objective thereof is to provide a liquid crystal display device of the FFS mode in which flickering and shifting of the optimum Vcom are suppressed.

A liquid crystal display device according to an embodiment of the present invention is a liquid crystal display device comprising: an active matrix substrate; a counter substrate opposed to the active matrix substrate; and a liquid crystal layer provided between the active matrix substrate and the counter substrate, the liquid crystal display device having a plurality of pixels arranged in a matrix shape, wherein, the active matrix substrate includes an alignment film provided so as to be in contact with the liquid crystal layer, the alignment film defining an initial alignment azimuth which is an alignment azimuth of liquid crystal molecules of a case where no electric field is applied to the liquid crystal layer, and a first electrode and a second electrode to generate a fringing field which causes the liquid crystal molecules to be aligned in an azimuth different from the initial alignment azimuth; the counter substrate includes a transparent substrate, and a third electrode provided on a side of the transparent substrate closer to the liquid crystal layer, the third electrode being opposed to the first electrode and the second electrode; the first electrode is a pixel electrode provided in each of the plurality of pixels; the second electrode is a common electrode which is provided in common for the plurality of pixels; and a DC voltage Vd is applied to the third electrode, the DC voltage Vd being different from a common voltage Vcom which is applied to the common electrode.

In one embodiment, 2. The liquid crystal display device of claim 1, wherein the DC voltage Vd is set within ±0.5 V of an optimum common voltage of a case where the third electrode does not have the DC voltage Vd applied thereto but is at a ground potential.

In one embodiment, the DC voltage Vd is set between 0 V and an optimum common voltage of a case where the third electrode does not have the DC voltage Vd applied thereto but is at a ground potential.

In one embodiment, the DC voltage Vd is set in a range of not less than +0.15 V of an optimum common voltage of a case where the third electrode does not have the DC voltage Vd applied thereto but is at a ground potential and not more than +0.3 V of the optimum common voltage of the case where the third electrode does not have the DC voltage Vd applied thereto but is at the ground potential.

In one embodiment, the DC voltage Vd is set so that a delta of an optimum common voltage after a screen image is kept lit at the 255^{th} gray scale level for 24 hours is within 50 mV.

In one embodiment, the DC voltage Vd is set so that a flicker level in a screen image lit at the 128^{th} gray scale level with a driving frequency of 24 Hz is −60 dB or less.

In one embodiment, the liquid crystal molecules has negative dielectric anisotropy.

In one embodiment, the alignment film is a photo-alignment film.

In one embodiment, the photo-alignment film is a photo-alignment film of a isomerization type, a decomposition type, or a dimerization type.

In one embodiment, the liquid crystal display device further comprises a backlight, wherein the photo-alignment film has a resistivity of 1×10¹³ Ω⋅cm or more while the backlight is activated.

In one embodiment, the liquid crystal display device is capable of being driven with a driving frequency of 40 Hz or less.

In one embodiment, the pixel electrode is disposed on the common electrode via an insulating layer.

In one embodiment, the insulating layer comprises a silicon nitride layer, a silicon oxide layer, or a silicon oxynitride layer.

In one embodiment, the insulating layer has a multilayer structure including two layers from among a silicon nitride layer, a silicon oxide layer, and a silicon oxynitride layer.

In one embodiment, the counter substrate further includes a color filter layer provided on a side of the transparent substrate closer to the liquid crystal layer, and an overcoat layer covering the color filter layer; the third electrode is provided on the overcoat layer; and the color filter layer, the overcoat layer, and the third electrode are disposed in this order from the transparent substrate.

In one embodiment, each of the first electrode, the second electrode, and the third electrode comprises ITO or IZO.

In one embodiment, the active matrix substrate further includes a TFT electrically connected to the pixel electrode; and the TFT includes an oxide semiconductor layer.

In one embodiment, the oxide semiconductor layer comprises an In—Ga—Zn—O based semiconductor.

In one embodiment, the In—Ga—Zn—O based semiconductor includes a crystalline portion.

An electronic apparatus according to an embodiment of the present invention comprises a liquid crystal display device having any of the above constructions.

According to an embodiment of the present invention, there is provided a liquid crystal display device of the FFS mode in which flickering and shifting of the optimum Vcom are suppressed.

### BRIEF DESCRIPTION OF THE DRAWINGS

FIG. 1 is a cross-sectional view schematically showing a liquid crystal display device 100 according to an embodiment of the present invention.

FIG. 2 is a cross-sectional view schematically showing a liquid crystal display device 800 according to Prototype Example 1.

FIG. 3 is a cross-sectional view schematically showing a liquid crystal display device 900 according to Prototype Example 2.

FIGS. 4A and 4B are graphs respectively concerning Prototype Examples 1 and 2 (relative to the optimum Vcom), each showing a relationship between the common voltage Vcom and the flicker level in a screen image lit at the 128^{th} gray scale level, with a driving frequency of 24 Hz.

FIGS. 5A and 5B are graphs respectively concerning Prototype Examples 1 and 2, each showing a flicker waveform in a screen image lit at the 128^{th} gray scale level at an optimum Vcom, with a driving frequency of 24 Hz.

FIGS. 6A and 6B are graphs respectively concerning Prototype Examples 1 and 2, each showing a flicker waveform in a screen image lit at the 128^{th} gray scale level at an optimum Vcom, with a driving frequency of 2 Hz

FIG. 7A is a graph concerning Prototype Example 3 (relative to the optimum Vcom when Vd=0 V)), showing a relationship between the common voltage Vcom and the flicker level in a screen image lit at the 128^{th} gray scale level with a driving frequency of 24 Hz, where the DC voltage Vd has a value of −1 V, −0.5 V, −0.3 V, 0 V, or +0.5 V.

FIG. 7B is a graph concerning Prototype Example 3 showing a Vd dependence of the flicker level as taken at the optimum Vcom (corresponding to each Vd value).

FIGS. 8A, 8B, 8C, 8D and 8E are graphs concerning Prototype Example 3, each showing a flicker waveform in a screen image lit at the 128^{th} gray scale level at an optimum Vcom corresponding to a respective Vd value, with a driving frequency of 24 Hz.

FIGS. 9A, 9B, 9C, 9D and 9E are graphs concerning Prototype Example 3, each showing a flicker waveform in a screen image lit at the 128^{th} gray scale level at an optimum Vcom corresponding to a respective Vd value, with a driving frequency of 2 Hz.

FIG. 10 is a diagram showing two displayed images (a frame-inverted image of the 128^{th} gray scale level and a screen image lit at the 255^{th} gray scale level) to be used in a Vcom shift assessment.

FIG. 11 is a graph showing results of Vcom shift assessment concerning Prototype Examples 1, 2, 3A and 3B.

FIG. 12 is a graph where the horizontal axis represents the voltage applied to the third electrode 21 and the vertical axis represents the amount of Vcom shift.

FIG. 13 is a cross-sectional view schematically showing an oxide semiconductor TFT 50.

### DETAILED DESCRIPTION

Hereinafter, with reference to the drawings, embodiments of the present invention will be described. Note that the present invention is not to be limited to the following embodiments.

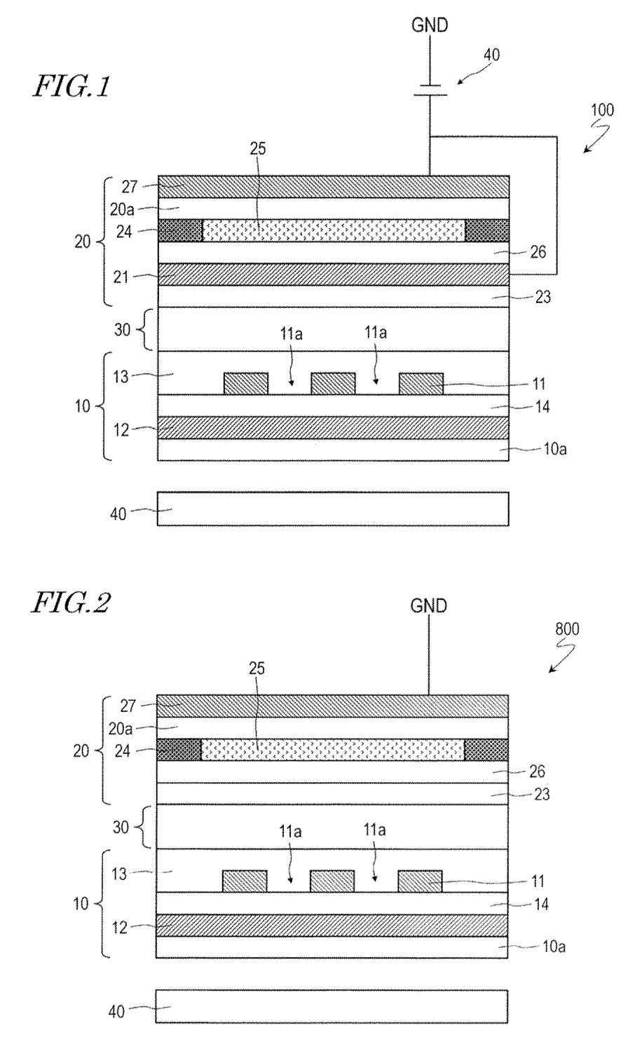

With reference to FIG. 1, a liquid crystal display device 100 according to the present embodiment will be described. FIG. 1 is a cross-sectional view schematically showing the liquid crystal display device 100. The liquid crystal display device 100 performs display in the FFS mode.

As shown in FIG. 1, the liquid crystal display device 100 includes: an active matrix substrate 10; a counter substrate 20 opposed to the active matrix substrate 10; a liquid crystal layer 30 provided between the active matrix substrate 10 and the counter substrate 20; and a backlight 40 provided on the rear face side of the active matrix substrate 10 (i.e., opposite side from the viewer's side). Moreover, the liquid crystal display device 100 includes a plurality of pixels that are arrayed in a matrix shape. FIG. 1 shows a cross-sectional structure corresponding to one pixel.

The active matrix substrate (also referred to as a “TFT substrate”) 10 includes a transparent substrate 10a, a first electrode 11, a second electrode 12, and an alignment film 13.

The transparent substrate 10a may be a glass substrate or a plastic substrate, for example. The first electrode 11, the second electrode 12, and the alignment film 13 are provided at the liquid crystal layer 30 side of the transparent substrate 10a, and are supported by the transparent substrate 10a.

The alignment film 13 is provided so as to be in contact with the liquid crystal layer 30 (i.e. located on the outermost surface at the liquid crystal layer 30 side of the active matrix substrate 10). The alignment film 13 defines an initial alignment azimuth of liquid crystal molecules. The initial alignment azimuth is an alignment azimuth of the liquid crystal molecules when no electric field is applied across the liquid crystal layer 30.

The first electrode 11 and the second electrode 12 generate a fringing field that causes the liquid crystal molecules to be aligned in an azimuth which is different from the initial alignment azimuth. The first electrode 11 and the second electrode 12 are each made of a transparent electrically-conductive material (e.g. ITO or IZO).

The first electrode 11 is a pixel electrode which is provided in each of the plurality of pixels. On the other hand, the second electrode 12 is a common electrode that is provided in common for the plurality of pixels. The pixel electrode 11 is disposed on the common electrode 12 via an insulating layer 14. The insulating layer 14 may be a silicon nitride (SiNx) layer, a silicon oxide (SiO₂) layer, or a silicon oxynitride (SiNxOy) layer, for example. Alternatively, the insulating layer 14 may have a multilayer structure including two layers among these. The pixel electrode 11 has at least one (e.g., two herein) slits 11a. The direction of the fringing field that is generated by the pixel electrode 11 and the common electrode 12 is a direction which is perpendicular to the direction that the slits 11a extend.

Although not shown herein, the active matrix substrate 10 further includes thin film transistors (TFT) provided for the respective pixels, scanning lines (gate lines) for supplying scanning signals (gate signals) to the TFTs, and signal lines (source lines) for supplying display signals (source signals) to the TFTs. To the gate electrode, the source electrode, and the drain electrode of each TFT, a scanning line, a signal line, and a pixel electrode 11 are respectively electrically connected. As the TFTs, oxide semiconductor TFTs may be suitably used. TFTs other than oxide semiconductor TFTs may also be used.

To each pixel electrode 11, a voltage (displaying voltage) corresponding to a display signal is applied via a TFT. To the common electrode 12, a voltage (common voltage) Vcom which is common to all pixels is applied. The common voltage Vcom is set to a value (optimum Vcom) that is optimum from the standpoint of flickering reduction.

The counter substrate (also referred to as a “color filter substrate”) 20 includes a transparent substrate 20a, a third electrode 21, and an alignment film 23.

The transparent substrate 20a may be a glass substrate or a plastic substrate, for example. The third electrode 21 and the alignment film 23 are provided at the liquid crystal layer 30 side of the transparent substrate 20a, and are supported by the transparent substrate 20a.

The alignment film 23 is provided so as to be in contact with the liquid crystal layer 30 (i.e., located on the outermost surface at the liquid crystal layer 30 side of the counter substrate 20). Similarly to the alignment film 13 of the active matrix substrate 10, the alignment film 23 defines an initial alignment azimuth of liquid crystal molecules. The alignment azimuth of liquid crystal molecules defined by the alignment film 23 is parallel or antiparallel to the alignment azimuth of liquid crystal molecules defined by the alignment film 13.

The third electrode 21 is opposed to the first electrode 11 and the second electrode 12. The third electrode 21 is made of a transparent electrically-conductive material (e.g. ITO or IZO). The third electrode 21 may be a single (continuous) electrically conductive film that is formed across the entire displaying region.

Tn the illustrated example, the counter substrate 20 further includes a light shielding layer (black matrix) 24, a color filter layer 25, an overcoat layer 26, and a transparent conductive layer 27.

The light shielding layer 24 and the color filter layer 25 are provided on the liquid crystal layer 30 side of the transparent substrate 20a. The color filter layer 25 may include, for example, red color filters, green color filters, and blue color filters.

The overcoat layer 26 covers the light shielding layer 24 and the color filter layer 25. The overcoat layer 26 is made of a transparent resin material, for example. The third electrode 21 is provided on the overcoat layer 26.

The transparent conductive layer 27 is provided on the opposite side (i.e., on the viewer's side) of the transparent substrate 20a from the liquid crystal layer 30. The transparent conductive layer 27 is made of a transparent electrically-conductive material (e.g. ITO or IZO). The transparent conductive layer 27 makes it possible to prevent electrostatic charging. The transparent conductive layer 27 may be omitted.

In the present embodiment, the liquid crystal layer contains liquid crystal molecules having negative dielectric anisotropy. In other words, the liquid crystal layer 30 is compose of a negative-type liquid crystal material. When the liquid crystal molecules has negative dielectric anisotropy, the alignment regulating force due to a fringing field alters the alignment azimuth of liquid crystal molecules in a manner of approaching an azimuth that is orthogonal to the direction of the fringing field.

The alignment films 13 and 23 disposed on both sides of the liquid crystal layer 30 are horizontal alignment films. Therefore, the liquid crystal molecules will be aligned substantially in parallel to the surfaces of the active matrix substrate 10 and the counter substrate 20. In the present embodiment, the alignment films 13 and 23 have undergone a photo-alignment treatment. In other words, the alignment films 13 and 23 are photo-alignment films. The photo-alignment films may be any of an isomerization type, a decomposition type, or a dimerization type. Photo-alignment films of an isomerization type, a decomposition type, and a dimerization type would be made of, respectively, materials which will undergo an isomerization reaction, a decomposition reaction, and a dimerization reaction with light irradiation (i.e., polymers containing such functional groups).

The backlight 40 emits light to be used for displaying. As the backlight 40, various known illuminators can be used.

Although not shown herein, the liquid crystal display device 100 further includes a pair of polarizing plates that are opposed to each other via at least the liquid crystal layer 30. The pair of polarizing plates are placed in crossed Nicols. The transmission axis of one of the pair of polarizing plates is substantially parallel to the initial alignment azimuth of the liquid crystal molecules, whereas the transmission axis of the other is substantially orthogonal to the initial alignment azimuth.

In the liquid crystal display device 100 of the present embodiment, a DC voltage Vd which is different from the common voltage Vcom that is applied to the common electrode 12 is applied to the third electrode 21. In the illustrated example, a DC power source 40 is connected to the third electrode 21 and the transparent conductive layer 27, so that a DC voltage is applied from the DC power source 40 to the third electrode 21 and the transparent conductive layer 27. In the present specification, whenever saying that “a DC voltage is applied”, the ground potential (0 V) being applied is not encompassed within the meaning.

As mentioned above, in the liquid crystal display device 100, a DC voltage Vd which is different from the common voltage Vcom is applied to the third electrode 21. This allows flickering and a shift in the optimum Vcom (which may hereinafter be simply referred to as a “Vcom shift”) to be suppressed. The reasons thereof will be described below.

In a generic liquid crystal display device of the FFS mode, electrodes are only provided on the active matrix substrate side, while no electrode exists on the counter substrate side. Therefore, it may be said that the active matrix substrate and the counter substrate are electrically asymmetric. Moreover, the pixel electrodes and the common electrode differ in terms of arrangement and shape, and there is also considerable electrical asymmetry between these electrodes (i.e., between the pixel electrodes and the common electrode). Therefore, polarities are likely to become more lopsided with driving, this being a factor causing a Vcom shift. Furthermore, due to the aforementioned complexity of the FFS mode electrode structure, even slight changes in the structure and/or material may result in a loss of electrical balance, thus altering the flicker level.

A number of factors exist that may make flickering more likely to be perceived, such as a loss of electrical balance, deteriorated reliability (lowering of the voltage holding ratio), flexoelectric effect, and so on. Presence of a vertical field in the liquid crystal layer is also considered a factor. A generic liquid crystal display device of the FFS mode, in which no electrode exists on the counter substrate side, is unable to control the magnitude of the vertical field, thus being unstable against charging of the counter substrate or the like.

In the liquid crystal display device 100 of the present embodiment, the counter substrate 20 includes the third electrode 21, which is provided on the liquid crystal layer 30 side of the transparent substrate 20a. Thus, by applying a DC voltage Vd to the third electrode 21, it is possible to control the magnitude of the vertical field in the liquid crystal layer 30, thereby being able to suppress flickering. Moreover, as will be described in more detail later, controlling the magnitude of the vertical field through application of a DC voltage Vd to the third electrode 21 also allows a Vcom shift to be suppressed.

Now, a result of studying suppression of flickering and Vcom shifts through control of the vertical field will be described.

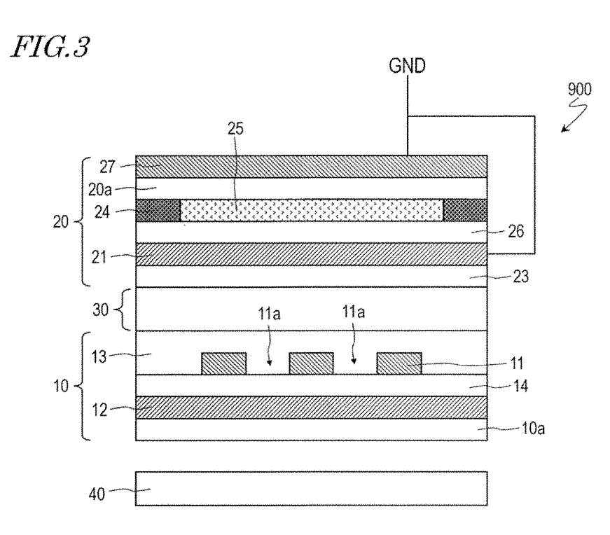

First, liquid crystal display devices 800 and 900 of Prototype Examples 1 and 2 as illustrated in FIG. 2 and FIG. 3 were produced, and subjected to flickering assessments.

The liquid crystal display device 800 of Prototype Example 1 differs from the liquid crystal display device 100 of the present embodiment in that the counter substrate 20 lacks the third electrode 21. The liquid crystal display device 900 of Prototype Example 2 differs from the liquid crystal display device 100 in that it lacks the DC power source 40, and that the third electrode 21 has the ground potential applied thereto (i.e., coupled to GND).

Flicker levels (JEITA values) of the liquid crystal display devices 800 and 900 of Prototype Examples 1 and 2 were measured while varying the common voltage Vcom. In the measurement, all pixels were lit at the 128^{th} gray scale level, and the driving frequency was 24 Hz. In the present specification, an “N^{th} gray scale level” refers to an N^{th} gray scale level in the case where displaying is performed between the 0^{th} gray scale level and the 255^{th} gray scale level (i.e., displaying in 256 gray scale levels). Therefore, the “128^{th} expression gray scale level” refers to the 128^{th} gray scale level under a scenario of displaying in 256 gray scale levels, whereas the expression “255^{th} gray scale level” refers to the 255^{th} gray scale level (i.e., the highest gray scale level) under a scenario of displaying in 256 gray scale levels. Measurement of the flicker level was performed with an optical characteristics evaluation device CA-310 available from Konica Minolta Corporation. During the measurement, as shown in FIG. 2 and FIG. 3, the ground potential was applied to the transparent conductive layer 27 of the counter substrate 20 of the liquid crystal display devices 800 and 900 of Prototype Examples 1 and 2. Note that the optimum Vcom in Prototype Examples 1 and 2 is about −0.34 V. Moreover, in Prototype Examples 1 and 2, the liquid crystal layer 30 is made of a negative type liquid crystal material having an anisotropy of dielectric constant Δ√ of −3.4, and the alignment films 13 and 23 are photo-alignment films having a resistivity of 1×10¹⁵ Ω⋅cm or more while the backlight 40 is activated (this similarly applies to Prototype Example 3 to be described below).

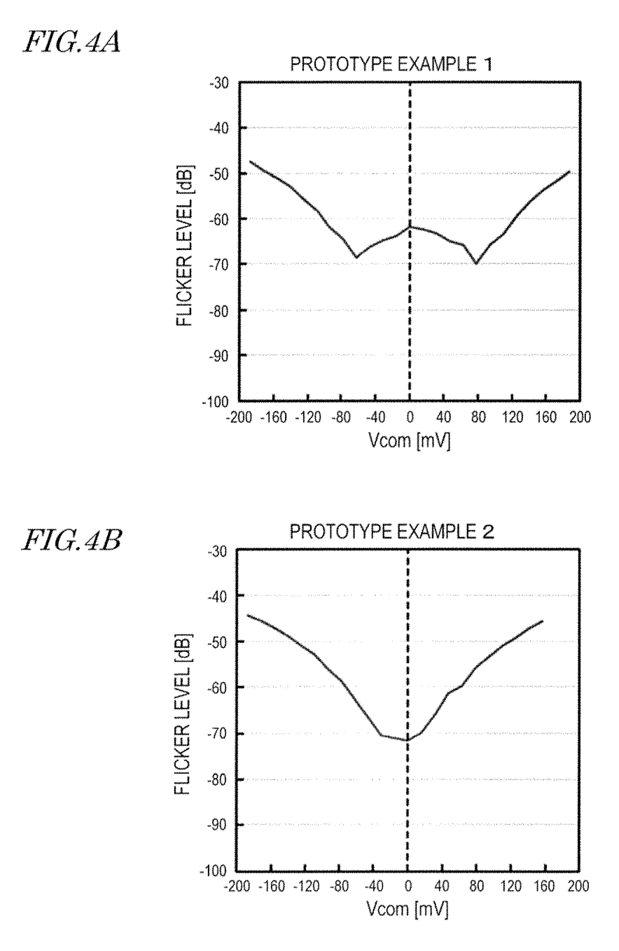

FIGS. 4A and 4B are graphs respectively concerning Prototype Examples 1 and 2, where the horizontal axis represents the common voltage Vcom and the vertical axis represents a 24 Hz component of the flicker level. The curve representing the relationship between the common voltage Vcom and the 24 Hz component of the flicker level is either “W” shaped (i.e., there are two points of local minimum) as shown in FIG. 4A, or “V” shaped (i.e., there is one point of local minimum) as shown in FIG. 4B. In the case where it is “V” shaped, the common voltage Vcom at the point of local minimum is the optimum Vcom; in the case where it is “W” shaped, a common voltage Vcom at a point of local maximum that exists between the two points of local minimum is the optimum Vcom. In FIGS. 4A and 4B, the optimum Vcom is taken at 0 on the horizontal axis (that is, each graph is referenced against the optimum Vcom). In the present specification, the 24 Hz component of the flicker level at the optimum Vcom is regarded as the flicker level of the liquid crystal display device.

In Prototype Example 1, the flicker level at the optimum Vcom was −61.79 dB. In Prototype Example 2, on the other hand, the flicker level at the optimum Vcom was −71.64 dB. In other words, the flicker level is improved by about 10 dB in Prototype Example 2, relative to Prototype Example 1. Thus, it was confirmed that the flicker level can be improved because of the third electrode 21 being included in the counter substrate 20.

Next, in the liquid crystal display devices 800 and 900 of Prototype Examples 1 and 2, all pixels were lit at the 128^{th} gray scale level, and their flicker waveforms at the optimum Vcom were measured by using a photodiode and an oscilloscope. The flicker waveform measurements were taken at driving frequencies of 24 Hz and 2 Hz.

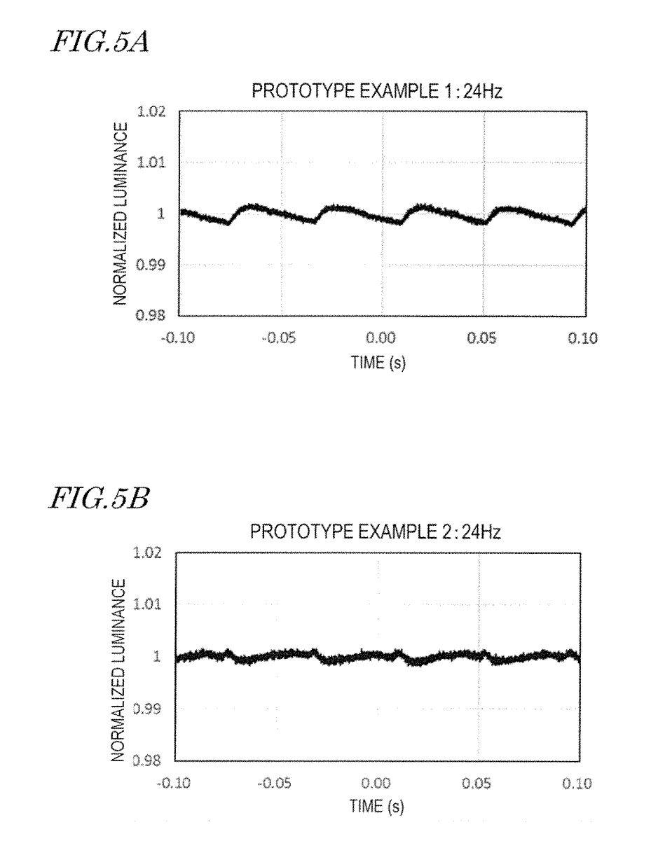

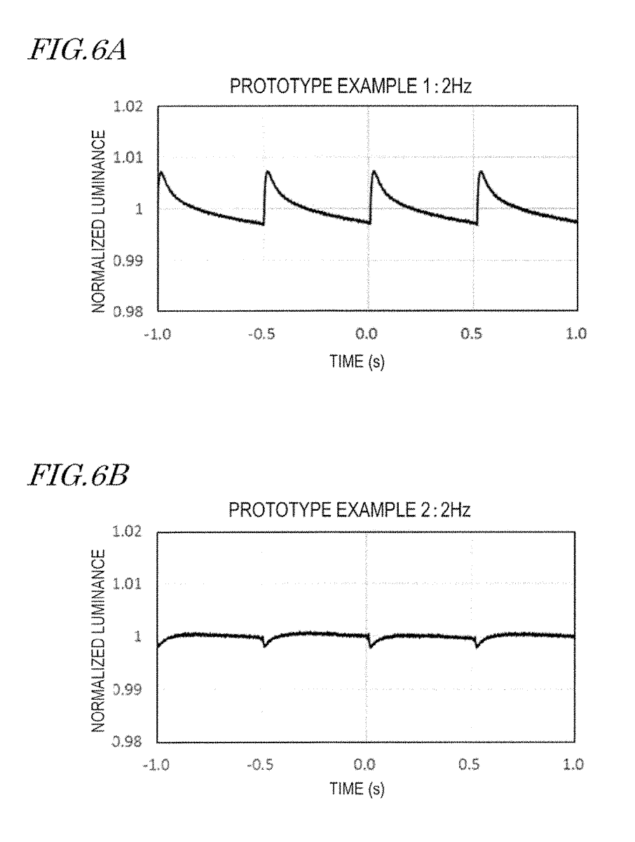

FIGS. 5A and 5B are graphs showing flicker waveforms at the optimum Vcom of Prototype Examples 1 and 2, respectively, with a driving frequency of 24 Hz. FIGS. 6A and 6B are graphs showing flicker waveforms at the optimum Vcom of Prototype Examples 1 and 2, respectively, with a driving frequency of 2 Hz.

From a comparison between FIG. 5A and FIG. 5B, and a comparison between FIG. 6A and FIG. 6B, it can be seen that flickering is improved in Prototype Example 2, relative to Prototype Example 1. In particular, the acute changes in luminance (see FIG. 6A) which are observed in Prototype Example 1 under driving at 2 Hz, occurring immediately after polarity inversion, are greatly reduced in Prototype Example 2 (see FIG. 6B).

Next, the liquid crystal display device 100 of the present embodiment was actually produced (Prototype Example 3), and its flickering was assessed. Specifically, the value of DC voltage Vd to be applied to the third electrode 21 was varied between −1 V and +0.5 V, and, at each voltage value, a flicker level and a flicker waveform were measured in similar manners to Prototype Examples 1 and 2. Note that the optimum Vcom when no voltage was being applied to the third electrode 21 was about −0.34 V.

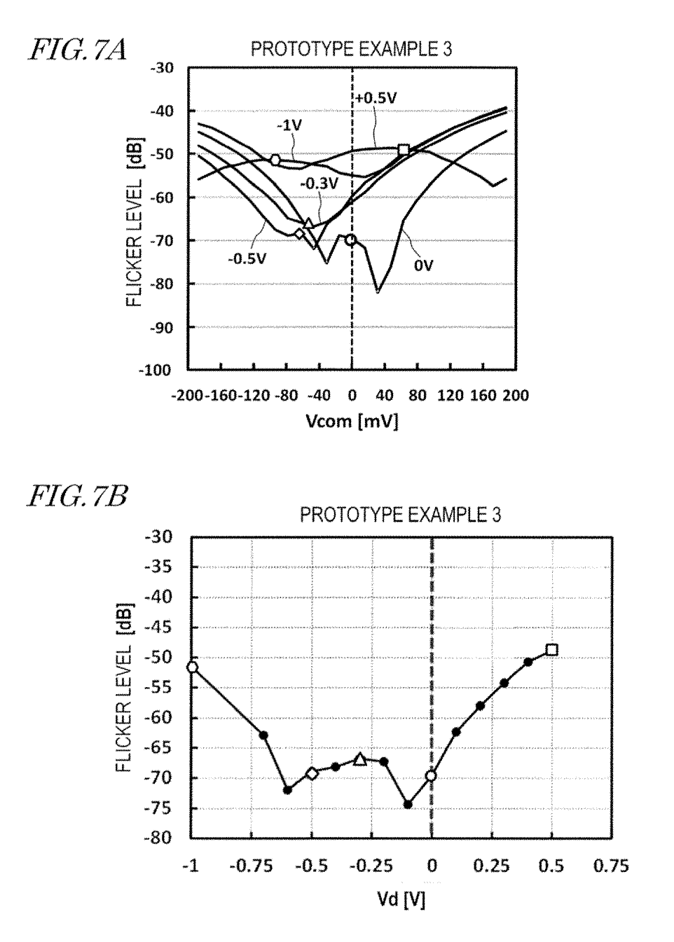

FIG. 7A is a graph concerning Prototype Example 3 (relative to the optimum Vcom when Vd=0 V) where the horizontal axis represents the common voltage Vcom and the vertical axis represents the flicker level (24 Hz component), regarding cases where the DC voltage Vd has values of −1 V, −0.5 V, −0.3 V and +0.5 V. For reference sake, FIG. 7A also shows the case where the third electrode 21 is at the ground potential (i.e., Vd=0 V)(the same is also true of FIG. 7B).

From FIG. 7A, it can be seen that by varying the DC voltage Vd applied to the third electrode 21, the flicker level undergoes systematic changes.

FIG. 7B is a graph concerning Prototype Example 3 where the horizontal axis represents the DC voltage Vd and the vertical axis represents the flicker level (24 Hz component), showing a Vd dependence of the flicker level as taken at the optimum Vcom corresponding to each Vd value.

As can be seen from FIG. 7B, the curve representing Vd dependence of the flicker level has a “W” shape which is centered around a point where Vd is an optimum Vcom of the case where the third electrode 21 does not have the DC voltage Vd applied thereto but is at the ground potential (about −0.34 V). Moreover, as can be seen from FIG. 7B, by setting the DC voltage Vd applied to the third electrode 21 within ±0.5 V of the optimum Vcom of the case where the third electrode 21 does not have the DC voltage Vd applied thereto but is at the ground potential, the flicker level (a flicker level in a screen image lit at the 128^{th} gray scale level under driving at 24 Hz) can be kept at a satisfactory level of −60 dB or less.

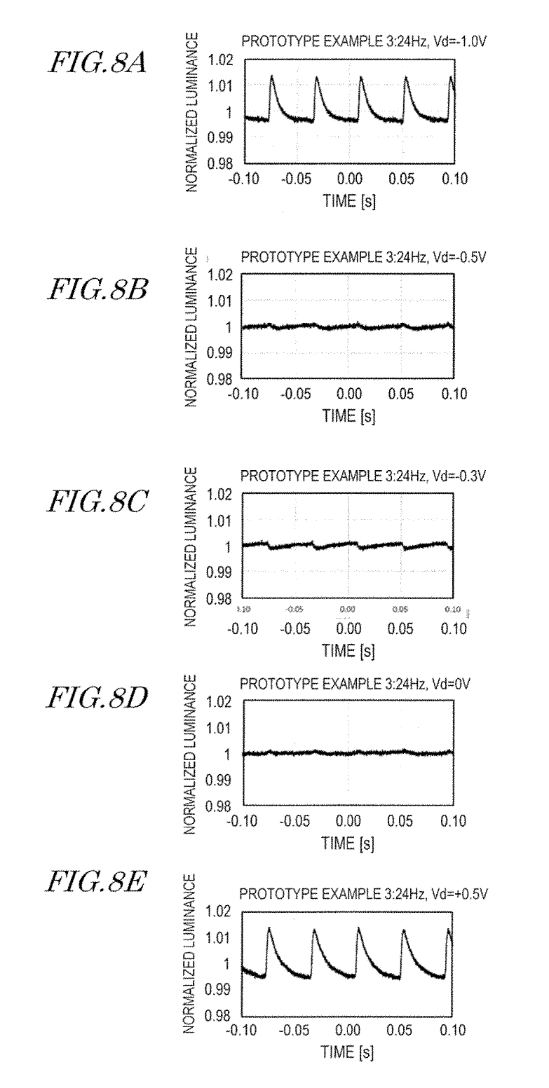

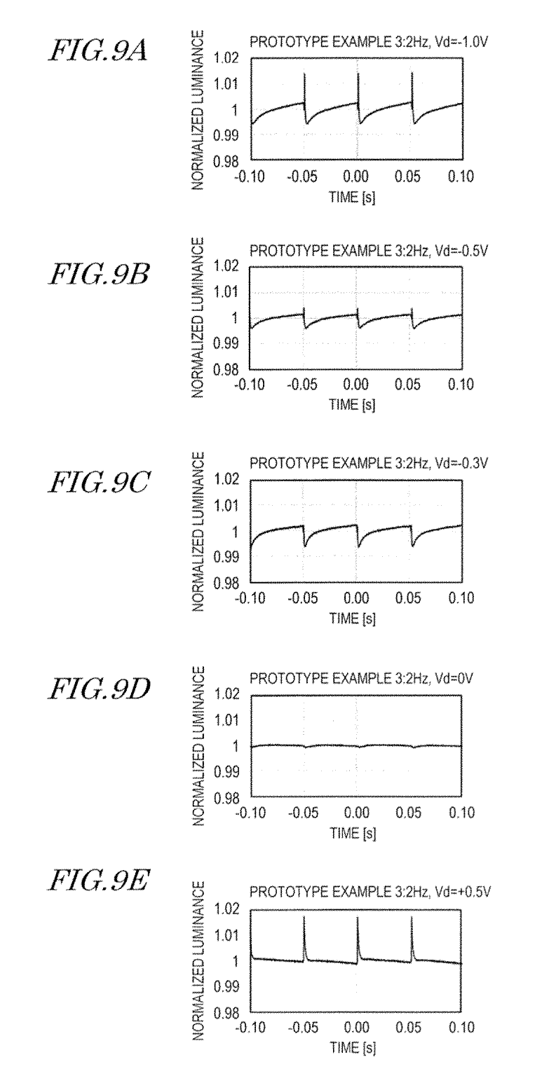

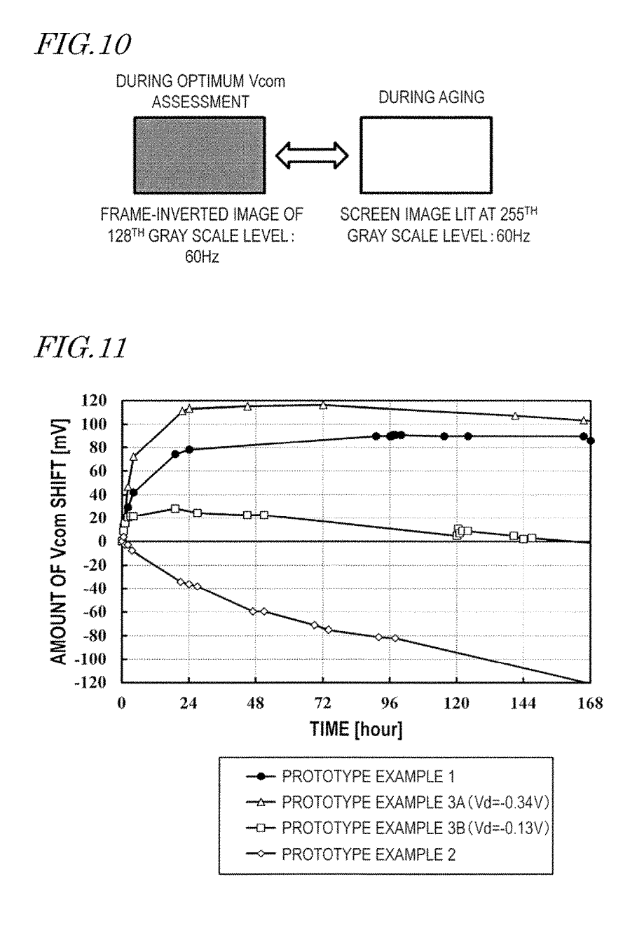

FIGS. 8A, 8B, 8C, 8D and 8E are graphs concerning Prototype Example 3, each showing a flicker waveform at the optimum Vcom corresponding to the respective Vd, with a driving frequency of 24 Hz. FIGS. 9A, 9B, 9C, 9D and 9E are graphs concerning Prototype Example 3, each showing a flicker waveform at the optimum Vcom corresponding to the respective Vd, with a driving frequency of 2 Hz. FIG. 8D and FIG. 9D, which are shown for reference sake, correspond to the case where the third electrode 21 is at the ground potential (i.e., Vd=0 V).

From FIGS. 8A through 8E and FIGS. 9A through 9E, it can be seen that varying the DC voltage Vd applied to the third electrode 21 alters the magnitude of the acute changes in luminance that occur immediately after polarity inversion. This is considered to be a phenomenon that is associated with the magnitude of the vertical field. Thus it is believed that, by controlling the magnitude of the acute changes in luminance through application of the DC voltage Vd to the third electrode 21, the flicker level can be reduced (and preferably minimized).

Next, Prototype Examples 1, 2 and 3 were subjected to Vcom shift assessments. As for Prototype Example 3, the assessment was taken by setting the DC voltage Vd applied to the third electrode 21 to either of the two values of −0.34 V and −0.13 V (hereinafter, these will respectively be referred to as Prototype Examples 3A and 3B).

The Vcom shift assessment is carried out through the following procedure.

(1) The module (i.e., the liquid crystal display device) is activated. As for Prototype Examples 3A and 3B, a voltage command value of the DC power source 40 is set to a desired value, and the DC voltage Vd is applied to the third electrode 21.

(2) The displayed image of the module is switched to a frame-inverted image of the 128^{th} gray scale level with a driving of frequency 60 Hz, as illustrated in the left-hand portion of FIG. 10.

(3) By using an optical characteristics evaluation device CA-310, the flicker level of the center of the displayed image on the module is measured while varying a command value for the common voltage Vcom (“Vcom command value”). The Vcom command value for when the flicker level is the lowest is regarded as the optimum Vcom.

(4) The displayed image on the module is switched to a screen image lit at the 255^{th} gray scale level with a driving frequency of 60 Hz, and left ON for a predetermined period of time (aging). The Vcom command value at this time is set to the optimum Vcom existing immediately before aging was begun.

(5) After the predetermined period of time has lapsed with the screen image ON, (2) and (3) are performed, and an optimum Vcom at this moment is determined.

(6) Thereafter, (4) and (5) are repeated.

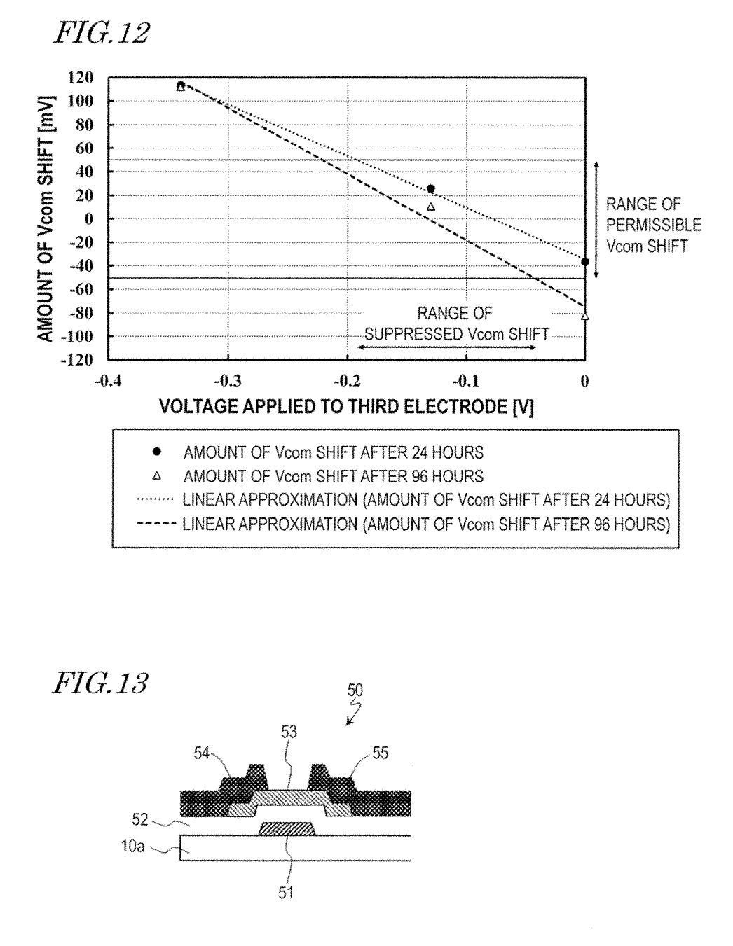

FIG. 11 shows assessment results of the amount of Vcom shift (i.e., a delta of the optimum Vcom relative to the optimum Vcom existing immediately before aging was begun). As seen from FIG. 11, in Prototype Example 1, a Vcom shift of about 60 mV is observed after 24 hours of activation, and a Vcom shift of about 90 mV is observed after 96 hours of activation. On the other hand, the behavior of Vcom shifts in Prototype Examples 2, 3A and 3B (each of which includes the third electrode 21) differs from that in Prototype Example 1, resulting in different behavior of the Vcom shift depending on the voltage being applied to the third electrode 21. In particular, in the case where the DC voltage Vd applied to the third electrode 21 is −0.13 V (Prototype Example 3B), the amount of Vcom shift up to 168 hours is kept at about 20 mV, which indicates that the behavior of the Vcom shift can be controlled with application of the DC voltage Vd to the third electrode 21. From a comparison between Prototype Examples 2, 3A and 3B, it can be seen that, from the standpoint of Vcom shift suppression, the DC voltage Vd applied to the third electrode 21 is preferably set between 0 V and an optimum Vcom of the case where the third electrode 21 does not have the DC voltage Vd applied thereto but is at the ground potential (i.e., about −0.34 V).

FIG. 12 is a graph in which the horizontal axis represents the voltage applied to the third electrode 21 and the vertical axis represents the amount of Vcom shift. Plotted in FIG. 12 are: the amounts of Vcom shift in the cases where the voltage applied to the third electrode 21 is −0.34 V, −0.13 V and 0 V, these values being taken either after 24 hours or after 96 hours. Moreover, the amount of Vcom shift is substantially linear with respect to the voltage applied to the third electrode 21. With different dotted lines, FIG. 12 also shows linear approximations of the data after 24 hours and the data after 96 hours.

A Vcom shift may be a cause for deteriorations in terms of flickering, image sticking, or the like; however, an amount of Vcom shift within ±50 mV (“range of permissible Vcom shift” in FIG. 12) will be presumably of little concern. In FIG. 12, a range of voltage in which the amounts of Vcom shift after 24 hours and after 96 hours both fit within ±50 mV is a range of not less than −0.19 V and not more than −0.04 V (“range of suppressed Vcom shift” in FIG. 12). In the module used for the assessment, an optimum Vcom of about −0.34 V exists when no voltage is applied to the third electrode 21; therefore the range of voltage in which the amount of Vcom shift fits within ±50 mV is a range of not less than [optimum Vcom +0.15 V] and not more than [optimum Vcom +0.3 V]. Therefore, from the standpoint of Vcom shift suppression, it can be said that the DC voltage Vd applied to the third electrode 21 is preferably set in a range of not less than +0.15 V of the optimum Vcom of the case where the third electrode 21 does not have the DC voltage Vd applied thereto but is at the ground potential and not more than +0.3 V of the optimum Vcom of the case where the third electrode 21 does not have the DC voltage Vd applied thereto but is at the ground potential.

As described above, according to an embodiment of the present invention, a liquid crystal display device of the FFS mode in which flickering and shifting of the optimum Vcom are suppressed can be provided.

Although an example has been illustrated where the liquid crystal molecules in the liquid crystal layer 30 have a negative dielectric anisotropy (i.e., the liquid crystal layer 30 is made of a negative-type liquid crystal material), the liquid crystal molecules in the liquid crystal layer 30 may have a positive dielectric anisotropy (i.e., the liquid crystal layer 30 may be made of a positive-type liquid crystal material).

Embodiments of the present invention will have a large significance for use in liquid crystal display devices having photo-alignment films as the alignment films, and in particular in liquid crystal display devices having photo-alignment films with large resistivity, because the Vcom shift will be more noticeable with photo-alignment films having large resistivity. Specifically, there will be large significance in using embodiments of the present invention when the photo-alignment film has a resistivity of 1×10¹³Ω⋅cm or more while the backlight is activated.

Moreover, from the standpoint of suppressing deteriorations in flickering, embodiments of the present invention will have a large significance for use in driving with a relatively low driving frequency, specifically, in driving with a driving frequency 40 Hz or less.

A liquid crystal display device according to an embodiment of the present invention can be suitably used in various electronic apparatuses such a smartphones or tablets.

<oxide semiconductor>

An oxide semiconductor TFT includes an oxide semiconductor layer as an active layer. The oxide semiconductor contained in the oxide semiconductor layer may be an amorphous oxide semiconductor, or a crystalline oxide semiconductor having a crystalline portion. Examples of crystalline oxide semiconductors include polycrystalline oxide semiconductors, microcrystalline oxide semiconductors, crystalline oxide semiconductors whose c axis is oriented essentially perpendicular to the layer plane, and so on.

The oxide semiconductor layer may have a multilayer structure of two or more layers. When the oxide semiconductor layer has a multilayer structure, the oxide semiconductor layer may include an amorphous oxide semiconductor layer and a crystalline oxide semiconductor layer. Alternatively, it may include a plurality of crystalline oxide semiconductor layers of different crystal structures. Moreover, it may include a plurality of amorphous oxide semiconductor layers. In the case where the oxide semiconductor layer has a two-layer structure including an upper layer and a lower layer, the energy gap of the oxide semiconductor that is contained in the upper layer is preferably greater than the energy gap of the oxide semiconductor that is contained in the lower layer. However, when the difference between the energy gaps of these layers is relatively small, the energy gap of the oxide semiconductor of the lower layer may be greater than the energy gap of the oxide semiconductor of the upper layer.

The material, structure, and method of film formation of an amorphous oxide semiconductor and each above crystalline oxide semiconductor, the construction of an oxide semiconductor layer having multilayer structure, etc., are described in Japanese Laid-Open Patent Publication No. 2014-007399, for example. The entire disclosure of Japanese Laid-Open Patent Publication No. 2014-007399 is incorporated herein by reference.

The oxide semiconductor layer may contain at least one metallic element among In, Ga, and Zn, for example. In the present embodiment, the oxide semiconductor layer contains an In—Ga—Zn—O based semiconductor (e.g. indium gallium zinc oxide), for example. Herein, the In—Ga—Zn—O based semiconductor is a ternary oxide of In (indium), Ga (gallium), Zn (zinc). The ratio between In, Ga, and Zn (composition ratio) is not particularly limited, and includes In:Ga:Zn=2:2:1, In:Ga:Zn=1:1:1, In:Ga:Zn=1:1:2, and the like, for example. Such an oxide semiconductor layer may be made from an oxide semiconductor film containing an In—Ga—Zn—O based semiconductor.

The In—Ga—Zn—O based semiconductor may be amorphous or crystalline. As the crystalline In—Ga—Zn—O based semiconductor, a crystalline In—Ga—Zn—O based semiconductor whose c axis is oriented essentially perpendicular to the layer plane is preferable.

Note that the crystal structure of a crystalline In—Ga—Zn—O based semiconductor is disclosed in, for example, Japanese Laid-Open Patent Publication No. 2014-007399, supra, Japanese Laid-Open Patent Publication No. 2012-134475, Japanese Laid-Open Patent Publication No. 2014-209727, and so on. The entire disclosures of Japanese Laid-Open Patent Publication No. 2012-134475 and Japanese Laid-Open Patent Publication No. 2014-209727 are incorporated herein by reference. A TFT including an In—Ga—Zn—O based semiconductor layer has a high mobility (20 times that of an a-Si TFT or greater) and a low leakage current (less than 1/100 times that of an a-Si TFT), and therefore is suitably used as a driving TFT (e.g., a TFT that is included in a driving circuit which is provided on the same substrate as the display region, near a display region including a plurality of pixels) or as a pixel TFT (a TFT that is provided in a pixel).

Instead of an In—Ga—Zn—O based semiconductor, the oxide semiconductor layer may contain any other oxide semiconductor. For example, it may contain an In—Sn—Zn—O based semiconductor (e.g. In₂O₃-SnO₂-ZnO; InSnZnO). An In—Sn—Zn—O based semiconductor is a ternary oxide of In (indium), Sn (tin), and Zn (zinc). Alternatively, the oxide semiconductor layer may contain an In—Al—Zn—O based semiconductor, an In—Al—Sn—Zn—O based semiconductor, a Zn—O based semiconductor, an In—Zn—O based semiconductor, a Zn—Ti—O based semiconductor, a Cd—Ge—O based semiconductor, a Cd—Pb—O based semiconductor, a CdO (cadmium oxide), an Mg—Zn—O based semiconductor, an In—Ga—Sn—O based semiconductor, an In—Ga—O based semiconductor, a Zr—In—Zn—O based semiconductor, an Hf—In—Zn—O based semiconductor, an Al—Ga—Zn—O based semiconductor, a Ga—Zn—O based semiconductor, an In—Ga—Zn—Sn—O based semiconductor, or the like.

An exemplary construction for the oxide semiconductor TFT is shown in FIG. 13. An oxide semiconductor TFT 50 shown in FIG. 13 includes a gate electrode 51, a gate insulating layer 52, an oxide semiconductor layer 53, a source electrode 54, and a drain electrode 55. Although the oxide semiconductor TFT 50 shown in FIG. 13 is a “channel-etch type”, the oxide semiconductor TFT may alternatively be an “etchstop type”.

<channel-etch>

In a channel-etch type TFT, as shown in FIG. 13, for example, no etchstop layer is formed in the channel region, and thus the lower faces of the ends of the source and drain electrodes that are closer to the channel are disposed in contact with the upper face of the oxide semiconductor layer. A channel-etch type TFT is formed by, for example, forming an electrically conductive film for the source/drain electrodes on the oxide semiconductor layer, and effecting source-drain separation. In the source-drain separation step, a surface portion of the channel region may become etched in some cases.

<etchstop>

On the other hand, in a TFT having an etchstop layer formed above the channel region (etchstop type TFT), the lower faces of the ends of the source and drain electrodes that are closer to the channel may be located above the etchstop layer, for example. An etchstop type TFT is formed by, for example, after forming an etchstop layer that covers a portion of the oxide semiconductor layer to become a channel region, forming an electrically conductive film for the source/drain electrodes upon the oxide semiconductor layer and the etchstop layer, and effecting source-drain separation.

According to an embodiment of the present invention, there is provided a liquid crystal display device of the FES mode in which flickering and shifting of the optimum Vcorn are suppressed.

This application is based on Japanese Patent Application No. 2018-70792 filed on Apr. 2, 2018, the entire contents of which are hereby incorporated by reference.

What is claimed is:

1. A liquid crystal display device comprising:
an active matrix substrate;
a counter substrate opposed to the active matrix substrate; and
a liquid crystal layer provided between the active matrix substrate and the counter substrate,
the liquid crystal display device having a plurality of pixels arranged in a matrix shape, wherein,
the active matrix substrate includes an alignment film provided so as to be in contact with the liquid crystal layer, the alignment film defining an initial alignment azimuth which is an alignment azimuth of liquid crystal molecules of a case where no electric field is applied to the liquid crystal layer, and
a first electrode and a second electrode to generate a fringing field which causes the liquid crystal molecules to be aligned in an azimuth different from the initial alignment azimuth;
the counter substrate includes
a transparent substrate, and
a third electrode provided on a side of the transparent substrate closer to the liquid crystal layer, the third electrode being opposed to the first electrode and the second electrode;
the first electrode is a pixel electrode provided in each of the plurality of pixels;
the second electrode is a common electrode which is provided in common for the plurality of pixels; and
a DC voltage Vd is applied to the third electrode, the DC voltage Vd being different from a common voltage Vcom which is applied to the common electrode.

2. The liquid crystal display device of claim 1, wherein the DC voltage Vd is set within ±0.5 V of an optimum common voltage of a case where the third electrode does not have the DC voltage Vd applied thereto but is at a ground potential.

3. The liquid crystal display device of claim 1, wherein the DC voltage Vd is set between 0 V and an optimum common voltage of a case where the third electrode does not have the DC voltage Vd applied thereto but is at a ground potential.

4. The liquid crystal display device of claim 1, wherein the DC voltage Vd is set in a range of not less than +0.15 V of an optimum common voltage of a case where the third electrode does not have the DC voltage Vd applied thereto but is at a ground potential and not more than +0.3 V of the optimum common voltage of the case where the third electrode does not have the DC voltage Vd applied thereto but is at the ground potential.

5. The liquid crystal display device of claim 1, wherein the DC voltage Vd is set so that a delta of an optimum common voltage after a screen image is kept lit at the 255^{th} gray scale level for 24 hours is within 50 mV.

6. The liquid crystal display device of claim 1, wherein the DC voltage Vd is set so that a flicker level in a screen image lit at the 128^{th} gray scale level with a driving frequency of 24 Hz is −60 dB or less.

7. The liquid crystal display device of claim 1, wherein the liquid crystal molecules has negative dielectric anisotropy.

8. The liquid crystal display device of claim 1, wherein the alignment film is a photo-alignment film.

9. The liquid crystal display device of claim 8, wherein the photo-alignment film is a photo-alignment film of an isomerization type, a decomposition type, or a dimerization type.

10. The liquid crystal display device of claim 8, further comprising a backlight, wherein
the photo-alignment film has a resistivity of 1×10¹³Ω⋅cm or more while the backlight is activated.

11. The liquid crystal display device of claim 1, which is capable of being driven with a driving frequency of 40 Hz or less.

12. The liquid crystal display device of claim 1, wherein the pixel electrode is disposed on the common electrode via an insulating layer.

13. The liquid crystal display device of claim 12, wherein the insulating layer comprises a silicon nitride layer, a silicon oxide layer, or a silicon oxynitride layer.

14. The liquid crystal display device of claim 13, wherein the insulating layer has a multilayer structure including two layers from among a silicon nitride layer, a silicon oxide layer, and a silicon oxynitride layer.

15. The liquid crystal display device of claim 1, wherein,
the counter substrate further includes a color filter layer provided on a side of the transparent substrate closer to the liquid crystal layer, and an overcoat layer covering the color filter layer;
the third electrode is provided on the overcoat layer; and
the color filter layer, the overcoat layer, and the third electrode are disposed in this order from the transparent substrate.

16. The liquid crystal display device of claim 1, wherein each of the first electrode, the second electrode, and the third electrode comprises ITO or IZO.

17. The liquid crystal display device of claim 1, wherein,
the active matrix substrate further includes a TFT electrically connected to the pixel electrode; and
the TFT includes an oxide semiconductor layer.

18. The liquid crystal display device of claim 17, wherein the oxide semiconductor layer comprises an In—Ga—Zn—O based semiconductor.

19. The liquid crystal display device of claim 18, wherein the In—Ga—Zn—O based semiconductor includes a crystalline portion.

20. An electronic apparatus comprising the liquid crystal display device of claim 1.
